(19) United States
(12) Patent Application Publication
(10) Pub. No.: US 2010/0208769 A1
(43) Pub. Date: Aug. 19, 2010

(54) Apparatus for determing and/or monitoring temperature

(75) Inventors: Andreas Martin, Nesselwang (DE); Detlef Schuttenberg, Kaufbeuren (DE)

Correspondence Address: BACON & THOMAS, PLLC, 625 SLATERS LANE, FOURTH FLOOR, ALEXANDRIA, VA, 22314-1176, US

(73) Assignee: Endress + Hauser Wetzer GmbH + Co. KG, Nesselwang (DE)

(21) Appl. No.: 12/452,949

(22) PCT Filed: Jul. 11, 2008
(86) PCT No.: PCT/EP2008/059129

§ 371 Date: Jan. 29, 2010

(30) Foreign Application Priority Data
Aug. 1, 2007 (DE) 10 2007 036 484.0

(51) Int. Cl. G01K 1/00

(52) U.S. Cl. 374/208; 374/E01.001

(57) ABSTRACT

An apparatus for determining and/or monitoring temperature, having: at least one housing, which has at least one inner space; and at least one cable duct for inserting at least one cable into an inner space of the housing; wherein the cable duct has at least one cable entrance and one cable exit opening into an inner space of the housing. The cable duct and the inner space of the housing are embodied and matched to one another in such a manner that the cable to be inserted in the cable duct extends essentially tangentially into the inner space of the housing, and is guided essentially radially in the inner space of the housing.

The invention relates to an apparatus for determining and/or monitoring temperature. The apparatus comprises: At least one housing, which has at least one inner space; and at least one cable duct for inserting at least one cable into an inner space of the housing, wherein the cable duct has at least one cable entrance, and a cable exit opening into the inner space of the housing.

In the state of the art, a number of temperature-measuring devices are known, which, most often, are composed of an actual sensor element, which generates a measured variable dependent on temperature, or on a change in temperature. An example is the electrical resistor of a resistance sensor. The sensor element is most often arranged outside of the actual housing, e.g. in a protective tube mounted on the housing. The electronics serving for the operation or further processing of the measured variable is most often arranged in a housing, or, more exactly, in the thermometer connection head.

For connecting the measuring device to the power supply, or to other devices or elements, it is necessary to insert a cable into the housing, and to contact there. As an example, Gebrauchsmuster DE 20 2006 004 923 U1 describes a cable duct for a field housing, in the case of which a curved stainless steel tube is involved. The tube is, in such case, arranged essentially below a terminal carrier, on which the terminals are located, with which terminals an inserted cable can be connected. It is disadvantageous that the cable duct is a complex component which requires an especially large amount of space in the housing.

An object of the invention is to provide a temperature-measuring device, in which the insertion of a cable is simplified and reliable, and in which the effort for this is as small as possible.

This object is achieved by the invention in that the cable duct and the inner space of the housing are embodied and matched to one another in such a manner, that the cable to be inserted in the cable duct extends essentially tangentially into the inner space of the housing, and is guided essentially radially in the inner space of the housing. The cable duct thus approaches the inner space of the housing tangentially, whereby the cable can be positioned relatively effortlessly. In the inner space of the housing itself, the cable is guided radially so that essentially no load is placed on the cable, and so that also the insertion of the cable into the inner space can be accomplished easily and without special effort. In other words, the cable is brought close to the side of the housing, and inserted into the inner space of the housing, where it then experiences a radial direction change. For this transition, or this change in direction of movement, it is—as explained further below—advantageous when, in the cable duct, a suitable bevel is provided, which produces a smooth path.

An embodiment provides that the inner space is embodied in such a manner that the cable in the inner space can be guided essentially kink freely. In the inner space, edges or protrusions, etc. are thus avoided so that the path in the inner space is smooth and resistance-free.

In an embodiment, the cable duct and the housing are embodied and matched to one another in such a way that the cable is guided spirally into the inner space.

An embodiment provides that the cable entrance and the cable exit essentially have an angle between 45° and 90° relative to one another. Especially the axial elongations of the cable entrance and the cable exit essentially form an angle between 45° and 90° relative to one another.

In an embodiment, the cable duct has at least one bevel, which is embodied in such a manner, that the bevel guides the cable in the direction of the cable exit. The bevel also has the effect that the transition takes place from tangential guiding to radial guiding. The bevel and the cable duct have in such case especially no sharp transitions. The cable duct is especially embodied in such a manner, that the cable is guided essentially kink freely. Furthermore, by means of the bevel, the cable duct is preferably embodied in such a manner that the cable can be inserted into the duct without special tools, and it comes back out on the opposite side, wherein especially a push on the cable is already sufficient. Special tools are thus especially not required. The bevel advantageously has as large an angle as possible for a transition that is as smooth as possible.

An embodiment provides that the bevel is embodied in such a manner, that the cable is guided in the cable duct essentially without bending.

In an embodiment, the bevel and the inner space of the housing are embodied and matched to one another in such a manner that the cable is guided from the cable exit into the inner space of the housing essentially kink freely.

An embodiment provides that the cable exit is located in the direction of an edge of the housing. The cable exit is thus on the side of the housing. Thus the space requirement for guiding in the inner space of the housing is especially small, since, in the inner space, the cable is at first guided along the wall of the housing. The cable is in such case preferably guided in such a manner, that it does not act disturbingly outside of the housing, that is, especially not in the area where a display is located. By means of lateral guiding, the cable can thus be easily inserted, and, especially, no requirements on the design of the housing arise.

In an embodiment, the cable exit is removed from a center of the housing.

An embodiment provides that the cable entrance and the cable exit lie essentially on a plane parallel to a floor of the housing. Also in this embodiment, the lateral mounting of the cable duct and essentially the “outer” guiding of the cable into the inner space are thus emphasized.

In an embodiment, the cable exit opens above a floor of the housing.

An embodiment provides that the cable duct is an integral component of the housing. The cable duct is a solid part the housing. Thus no additional components or steps in the manufacturing process are required; rather, the housing is produced as a whole with the cable duct. The one-piece embodiment is thereby attained, for example, in that the lower part of the housing is produced with the cable duct using an injection molding method, as an aluminum die casting, a stainless steel lost wax casting, or as a deep drawn part. Another option for manufacturing the thermometer connection head is to weld the cable duct onto a milled part.

In an embodiment, the housing is essentially cup-shaped.

An embodiment provides that the inner space of the housing is essentially cylindrical.

In an embodiment, the housing is a single-chamber housing. Occasionally, there are two- or multi-chamber housings, which, through the individual chambers, produce a separation between different zones, e.g. between Ex- and non-Ex-regions. This embodiment, however, concerns a single-chamber housing, i.e. the inner space extends throughout the housing as a single chamber. Especially only one inner space is thus provided in the housing.

The invention will now be explained in greater detail on the basis of the appended drawings, the figures of which show as follows:

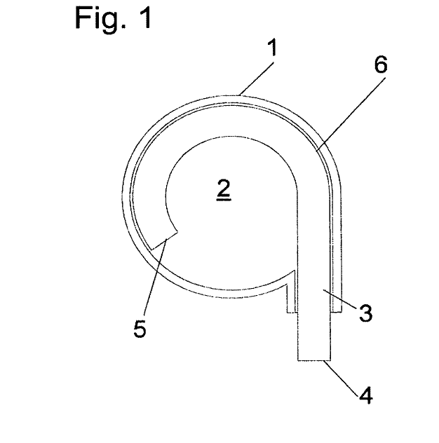

FIG. 1 a section through the housing of the measuring device of the invention, and

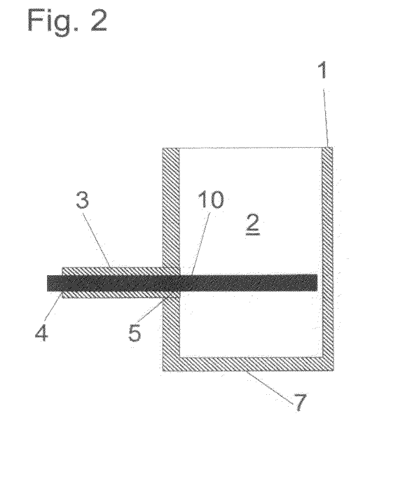

FIG. 2 an additional section through the device of FIG. 1.

FIG. 1 shows a schematic section through the housing 1. In this housing 1 is located, for example, the electronics for measuring or evaluating the temperature, or, for example, also the connection for the actual sensor unit (e.g. a measuring resistor—Pt100—in a protective tube, which is inserted at the process or into the medium). For example, also located in the inner space 2 is the measurement transmitter, which serves for operating the actual measuring sensor, or the sensor unit, and/or evaluating or further processing the measured values of the sensor with respect to temperature. These components are not illustrated here, in order to avoid clutter. A terminal location (not shown here), at which the cable to be inserted is connected, is found especially in the housing 1, or in the inner space 2 of the housing 1.

The entrance of the cable duct 3 is located on the side of the housing 1, so that the cable is brought closer tangentially to the inner space 2. Thus, especially, no special tool is required, but rather a simple forwardly directed force is sufficient for inserting the cable into the inner space 2. Especially also the “threading” of the cable is simplified.

By means of the bevel 6, the cable is turned into the radial guide in the inner space 2. Here in the inner space 2, the cable is guided along the wall, and first then leaves the cable exit 5. In such a case, in the inner space 2, the cable duct 3 can be closed so that it envelops the cable like a shell, or it be can partially open, so that instead the cable rests in the correspondingly embodied wall of the inner space 2.

The lateral section of FIG. 2 clarifies the cup-like embodiment of the housing 1, whose inner space 2 here is composed of only a single chamber. On the side of the housing 1, the cable duct 3 for the cable 10 is provided, which is located especially also above the floor 7 of the housing 1. The cable entrance 4 and the cable exit 5 are located essentially on the same plane. In an additional embodiment, the cable entrance 4 and the cable exit 5 are located on different levels or planes, wherein the cable duct 3 winds in a spiral path. The cable duct 3 is an integral component of the housing 1. Also connected to the housing 1 is, for example, a protective tube (not shown), in which the actual sensor element is arranged. The protective tube is then, for example, inserted into a container or in a pipe or generally into the area of the process whose temperature is to be measured or monitored.

### LIST OF REFERENCE CHARACTERS

1 housing
2 inner space
3 cable duct
4 cable entrance
5 cable exit
6 bevel
7 floor
10 cable

1-14. (canceled)

15. In an apparatus for determining and/or monitoring temperature, the improvement comprising:
at least one housing, which has at least one inner space; and
at least one cable duct for insertion of at least one cable into said inner space of said housing, wherein:
said cable duct has at least one cable entrance and one cable exit opening into said inner space of said housing;
said cable duct and said inner space of said housing are embodied and matched to one another in such a manner that the cable to be inserted in said cable duct extends essentially tangentially into said inner space of said housing, and, in said inner space of said housing, is guided essentially radially.

16. In the apparatus as claimed in claim 15, wherein:
said inner space is embodied in such a manner, that said cable is guided in said inner space essentially kink freely.

17. In the apparatus as claimed in claim 15, wherein:
said cable duct and said housing are embodied and matched to one another in such a manner that the cable is guided into said inner space along a spiral path.

18. In the apparatus as claimed in claim 15, wherein:
said cable entrance and said cable exit essentially have an angle between 45° and 90° relative to one another.

19. In the apparatus as claimed in claim 15, wherein:
said cable duct has at least one bevel, which is embodied in such a manner, that said bevel guides the cable in the direction of said cable exit.

20. In the apparatus as claimed in claim 19, wherein:
said bevel is embodied in such a manner that the cable is guided in said cable duct essentially kink freely.

21. In the apparatus as claimed in claim 19, wherein:
said bevel and said inner space of said housing are embodied and matched to one another in such a manner that the cable is guided essentially kink freely from the cable entrance into said inner space of said housing.

22. In the apparatus as claimed in claim 15, wherein:
said cable exit is located in the direction of an edge said housing.

23. In the apparatus as claimed in claim 15, wherein:
said cable exit is removed from a center of said housing.

24. In the apparatus as claimed in claim 15, wherein:
said cable entrance and said cable exit lie essentially on a plane parallel to a floor of said housing.

25. In the apparatus as claimed in claim 15, wherein:
said cable exit opens out above a floor of said housing.

26. In the apparatus as claimed in claim 15, wherein:
said cable duct is an integral component of said housing.

27. In the apparatus as claimed in claim 15, wherein:
said housing is essentially cup-shaped.

28. In the apparatus as claimed in claim 15, wherein:
said inner space of said housing is essentially cylindrical.
